(19) United States
(12) Patent Application Publication
(10) Pub. No.: US 2024/0377557 A1
(43) Pub. Date: Nov. 14, 2024

(54) Optical Element with a Lanthanide Compound Layer

(71) Applicant: Vactronics Technologies Inc., Miaoli County (TW)

(72) Inventors: Sen-Tsung HSIAO, MIAOLI COUNTY (TW); Chih-Hung CHU, MIAOLI COUNTY (TW); Wei-Li WAN, MIAOLI COUNTY (TW); Shi-Chun ZHOU, MIAOLI COUNTY (TW); Chia-Sheng TSAI, MIAOLI COUNTY (TW)

(21) Appl. No.: 18/334,490

(22) Filed: Jun. 14, 2023

(30) Foreign Application Priority Data
May 10, 2023 (TW) 112117276

(51) Int. Cl. G02B 1/115

(52) U.S. Cl. CPC G02B 1/115

(57) ABSTRACT

An optical element with a lanthanide compound layer in accordance with the present invention comprises: an optical substrate including a first surface; the lanthanide compound layer made of lanthanide compound and being disposed on the first surface, and the lanthanide compound layer including a second surface; and an optical film stack disposed on the second surface. With the design of the lanthanide compound layer, the optical element has a blocking effect. Therefore, during the cleaning process of the optical element, a large number of particles can be removed, while effectively suppressing the expansion and generation of pinhole defects, and maintaining the original performance of the optical element.

### BACKGROUND

### Field of the Invention

The present invention relates to an optical element, and more particularly to an optical element with a lanthanide compound layer.

### Description of Related Art

Generally, in order to improve the performance of optical elements or change the transmission characteristics of light waves, it is usually necessary to deposit a group of optical film stacks on the surface of the optical substrate.

Refer to FIG. 1A, which shows an optical element 10 formed by coating an optical film stack 12 on an optical substrate 11. When coating is performed on the surface of the optical substrate 11, it will be affected by the adjustment of coating parameters and the environment inside the machine chamber, so that, after the optical film stack 12 is formed, many pinhole defects 121 and particles 122 will appear on the surface. Among them, the pinhole defects 121 refer to surface defects of different depths produced in the process of optical coating. The particles 122 refer to the surface pollutants in the coating, including environmental dust and coating spray adhesion, etc. In order to avoid the generation of the particles 122 affecting the performance of the optical element 10, the optical element 10 will be cleaned to remove a large number of particles.

However, as shown in FIG. 1B, after the cleaning of the optical element 10, although most of the particles 122 on the optical film stack 12 are removed, the number of the pinhole defects 121 on the optical film stack 12 will increase, or the original pinhole defects 121 on the optical film stack 12 will become larger and deeper. As a result, the optical film stack 12 is seriously damaged in the process of cleaning, and the performance of the optical element 10 is adversely affected.

### SUMMARY

One objective of the present invention is to provide an optical element with a lanthanide compound layer, mainly by removing particles to avoid affecting the performance of the optical element.

To achieve the above objective, an optical element with a lanthanide compound layer in accordance with the present invention comprises: an optical substrate including a first surface; the lanthanide compound layer made of lanthanide compound and being disposed on the first surface, and the lanthanide compound layer including a second surface; and an optical film stack disposed on the second surface.

The advantage of the present invention is that with the design of the lanthanide compound layer, the optical element has a blocking effect. Therefore, during the cleaning process of the optical element, a large number of particles can be removed, while effectively suppressing the expansion and generation of pinhole defects, and maintaining the original performance of the optical element.

Preferably, the thickness of the lanthanide compound layer ranges from 5 nm to 100 nm. Therefore, when the thickness of the lanthanide compound layer is less than 5 nm, the suppression effect of expansion and generation of the pinhole defects is poor, but it does not cause deformation in certain spectral bands. When the thickness of the lanthanide compound layer is greater than 100 nm, the suppression effect of expansion and generation of the pinhole defects is better, but it is easy to cause deformation in certain spectral bands.

Preferably, the lanthanide compound layer is made of a material selected from the group consisting of LaTiO3, LaNiO3 and LaAlO.

Preferably, a thickness ratio between the lanthanide compound layer and the optical film stack is 1-900:1000-9000. When the thicknesses of the lanthanide compound layer and the optical film stack meet the aforementioned ratio, it will effectively suppress the expansion and generation of the pinhole defects, while not causing deformation in certain spectral bands.

### BRIEF DESCRIPTION OF THE DRAWINGS

FIG. 1A is a schematic diagram of the conventional optical element, showing the state of an optical film stack coated on an optical substrate;

FIG. 1B is a schematic diagram of the conventional optical element, showing the state of the optical element after the cleaning process;

FIG. 2A is a schematic diagram of the invention;

FIG. 2B is a schematic diagram of the invention, showing the state of the optical element after the cleaning process;

FIG. 3A is a curved graph of the invention showing the increase rate of the pinhole defect after the cleaning process when the size of pinhole defect of both the invention and the conventional optical element is less than 3 μm; and

FIG. 3B is a curved graph of the invention showing the increase rate of the pinhole defects after the cleaning process when the size of the pinhole defects of both the invention and the conventional optical element is between 3 μm-10 μm.

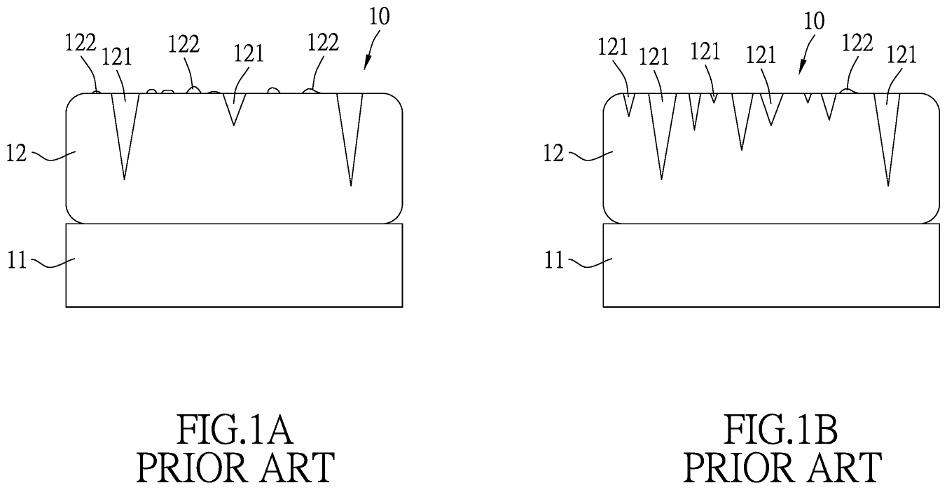

### DETAILED DESCRIPTION

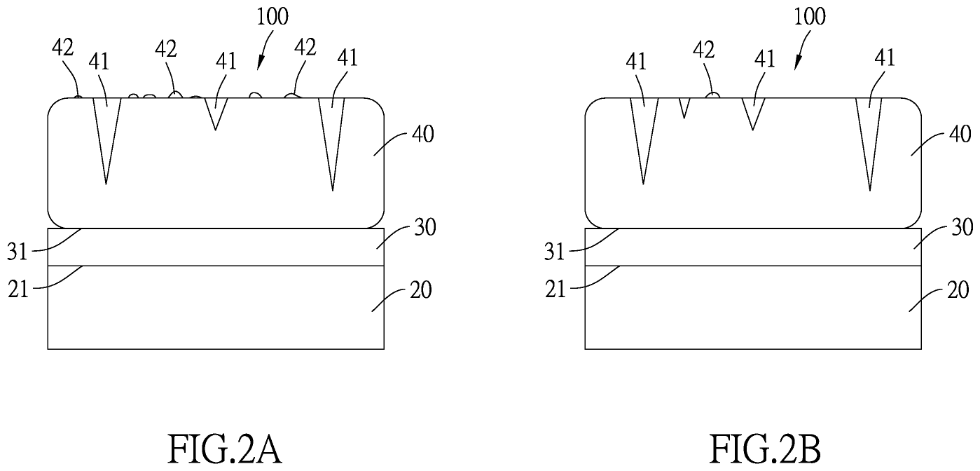

As shown in FIG. 2A, the embodiment of the invention provides the structure of an optical element 100 with a lanthanide compound layer, which essentially includes: an optical substrate 20, a lanthanide compound layer 30, and an optical film stack 40.

The optical substrate 20 includes a first surface 21. In this embodiment, the optical substrate 20 is a glass wafer, but not limited to this, or a sodium-calcium/boron-series/aluminosilicate glass substrate.

The lanthanide compound layer 30, made of lanthanide compound, is disposed on the first surface 21, and the lanthanide compound layer 30 includes a second surface 31. In this embodiment, the lanthanide compound layer 30 is made of lanthanum titanate (LaTiO3), but not limited to this, it can also be lanthanum nickelate (LaNiO3) or lanthanum alumina (LaAlO). In addition, the thickness of the lanthanide compound layer 30 is 20 nm, but not limited to this, the thickness of the lanthanide compound layer 30 can range from 5 nm to 100 nm. In addition, the manufacturing method of the lanthanide compound layer 30 can be evaporation, sputtering, plasma induction, inductively coupled plasma (ICP), or atomic layer deposition (ALD), and other optical film growth methods, but not limited to such methods.

The optical film stack 40 is disposed on the second surface 31. In this embodiment, the optical film stack 40 is an Anti Reflection Coating, also known as AR coating, which can reduce the reflection phenomenon of the optical element 100 and reduce the loss of light passing through, but is not limited to this. It can also be a High-Reflectance Coating (also known as HR coating), a Band Pass Filter (BPF), an indium Tin Oxide (ITO) film, or a F-doped tin oxide (FTO) film. In addition, during the generation of the optical film stack 40, a large number of pinhole defects 41 and particles 42 are generated on the surface of the optical film stack 40. The shapes and sizes of the pinhole defects 41 and the particles 42 in the drawings are only presented in a schematic manner. In this embodiment, the thickness ratio between the lanthanide compound layer 30 and the optical film stack 40 is 1-900:1000-9000.

The above is the description of the main components of the embodiment of the invention. The efficacy of the invention is described as follows:

Accordingly, referring to FIG. 2A and FIG. 2B, the invention makes the optical element 100 have a blocking effect by providing the lanthanide compound layer 30 between the optical substrate 20 and the optical film stack 40. Therefore, when the optical element 100 is in the cleaning process, in addition to effectively removing most of the particles (particles 42), the number of the pinhole defects 41 in the optical film stack 40 will not be increased significantly, or the original pinhole defects 41 in the optical film stack 40 will be greatly enlarged and deepened. Therefore, the invention can effectively inhibit the expansion and generation of the pinhole defects 41, so as to maintain the original performance of the optical element 100.

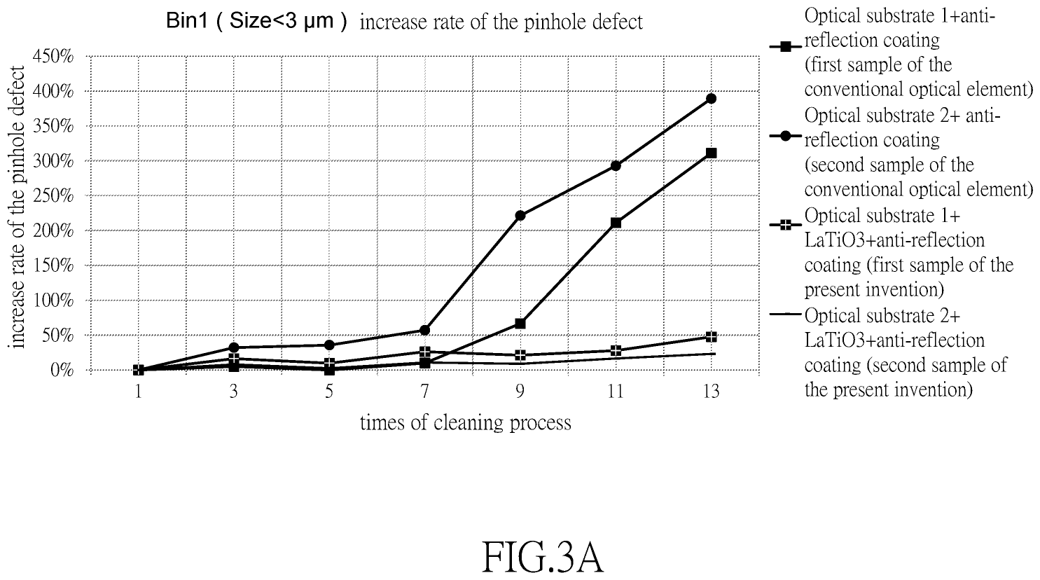

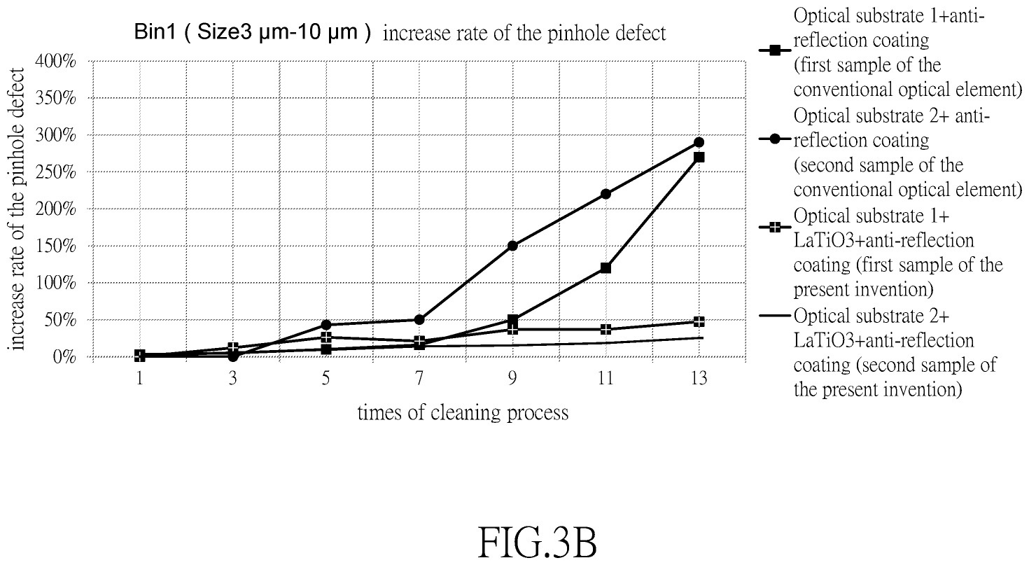

FIG. 3A shows the increase rate of the pinhole defect after the cleaning process when the size of pinhole defect of both the invention and the conventional optical element is less than 3 μm. It is clear from FIG. 3A that the optical element of the invention has the lanthanide compound layer (lanthanum titanate) between the optical substrate and the optical film stack, while the conventional optical element is only composed of an optical substrate and an optical film stack, when both of them are cleaned for the tenth time, the increase rate of the pinhole defects in the first and second samples of the optical element of the invention is about 25% at the highest, while the increase rate of the pinhole defects in the first and second samples of the conventional optical element is about 140% at the lowest and more than 250% at the highest. Besides, as the times of cleaning process increases, the difference in the increase rate of the pinhole defects between the conventional optical element and the present invention increases, indicating that the present invention can effectively suppress the expansion and generation of pinhole defects during the cleaning process, and maintain the original performance of the optical element.

FIG. 3B shows the increase rate of the pinhole defects after the cleaning process when the size of the pinhole defects of both the invention and the conventional optical element is between 3 μm-10 μm. It is clear from FIG. 3B that the optical element of the invention has the lanthanide compound layer (lanthanum titanate) between the optical substrate and the optical film stack, while the conventional optical element is only composed of an optical substrate and an optical film stack, when both of them are cleaned for the eleventh time, the increase rate of the pinhole defects in the first and second samples of the optical element of the invention is about 50% at the highest, while the increase rate of the pinhole defects in the first and second samples of the conventional optical element is about 120% at the lowest and more than 220% at the highest. Besides, as the times of cleaning process increases, the difference in the increase rate of the pinhole defects between the conventional optical element and the present invention increases, indicating that the present invention can effectively suppress the expansion and generation of pinhole defects during the cleaning process, and maintain the original performance of the optical element.

It is worth noting that the lanthanide compound layer 30 is specially arranged between the optical substrate 20 and the optical film stack 40. Therefore, the lanthanide compound layer 30 can be used as a binding layer to increase the adhesion of the optical film stack 40 during coating, and it can also be used for coating by an evaporation machine.

On the other hand, the invention specifically limits the thickness range of the lanthanide compound layer 30 to 5 nm to 100 nm. Therefore, when the thickness of the lanthanide compound layer 30 is less than 5 nm, the suppression effect of expansion and generation of the pinhole defects 41 is poor, but it does not cause deformation in certain spectral bands. When the thickness of the lanthanide compound layer 30 is greater than 100 nm, the suppression effect of expansion and generation of the pinhole defects 41 is better, but it is easy to cause deformation in certain spectral bands. In addition, the thickness ratio between the lanthanide compound layer 30 and the optical film stack 40 is 1-900 to 1000-9000. Therefore, when the thicknesses of the optical substrate 20, the lanthanide compound layer 30, and the optical film stack 40 meet the aforementioned ratio, it will effectively suppress the expansion and generation of the pinhole defects 41, while not causing deformation in certain spectral bands.

What is claimed is:

1. An optical element with a lanthanide compound layer, comprising:
an optical substrate including a first surface;
the lanthanide compound layer made of lanthanide compound and being disposed on the first surface, and the lanthanide compound layer including a second surface; and
an optical film stack disposed on the second surface.

2. The optical element with the lanthanide compound layer as claimed in claim 1, wherein a thickness of the lanthanide compound layer ranges from 5 nm to 100 nm.

3. The optical element with the lanthanide compound layer as claimed in claim 1, wherein the lanthanide compound layer is made of a material selected from the group consisting of LaTiO3, LaNiO3 and LaAlO.

4. The optical element with the lanthanide compound layer as claimed in claim 1, wherein a thickness ratio between the lanthanide compound layer and the optical film stack is 1-900:1000-9000.
